(19) United States
(12) Patent Application Publication
(10) Pub. No.: US 2025/0098891 A1
(43) Pub. Date: Mar. 27, 2025

(54) MOVING STRUCTURE FOR GROUP HEAD AND COFFEE MACHINE

(71) Applicant: Tsann Kuen (Zhangzhou) Enterprise Co., Ltd., Zhangzhou City (CN)

(72) Inventors: Guowei HUANG, Zhangzhou City (CN); Zelin Guo, Zhangzhou City (CN); Qingyuan Chen, Zhangzhou City (CN)

(21) Appl. No.: 18/809,692

(22) Filed: Aug. 20, 2024

(30) Foreign Application Priority Data
Sep. 26, 2023 (CN) 202322623155.8

(51) Int. Cl. A47J 31/44; A47J 31/46

(52) U.S. Cl. CPC A47J 31/4482; A47J 31/46

(57) ABSTRACT

This application provides a moving structure for a group head and a coffee machine. The moving structure for a group head includes a front plate, a magnetic conductive plate, magnets, and a moving plate. The front plate is provided with a guide opening, and the magnetic conductive plate is fixed to a rear side portion of the front plate. The magnets are assembled on the moving plate, and the moving plate is slidably assembled in the guide opening and corresponds to the magnetic conductive plate. The group head is fixed on the moving plate, and in the absence of an external force, the group head remains stationary due to attraction of the magnets. In this way, direct friction is reduced, and service life can be effectively prolonged.

### CROSS-REFERENCE TO RELATED APPLICATIONS

This application claims priority to Chinese Patent Application 202322623155.8, filed on Sep. 26, 2023, which is incorporated herein by reference.

### TECHNICAL FIELD

This application relates to the field of coffee machines, and in particular to a moving structure for a group head and a coffee machine having the moving structure for a group head.

### BACKGROUND

A coffee machine is a machine for making coffee. In the prior art, a group head may be either fixed or movable up and down. A fixed group head cannot perfectly adapt to different heights of cups. If the cup is too high, it cannot be placed properly, and if the cup is too short, the coffee is prone to splash out. A group head movable up and down can avoid the above problem.

At present, the group head movable up and down is generally fixed by means of friction. That is, in the absence of an external force, the group head is fixed by means of friction at the connecting part. When an external force is applied, the group head moves up and down against the friction. However, in this way, repeated movement of the group head will cause frictional loss, and finally, the group head will lose its function.

### SUMMARY

Therefore, in order to alleviate the above problems, this application provides a moving structure for a group head and a coffee machine.

In order to achieve the above objective, this application provides the following technical solution:

A moving structure for a group head includes a front plate, a magnetic conductive plate, magnets, and a moving plate. The front plate is provided with a guide opening running through the front plate from front to rear, and the magnetic conductive plate is fixed to a rear side portion of the front plate. The magnets are assembled on the moving plate. The moving plate is slidably assembled in the guide opening and corresponds to the magnetic conductive plate, and the moving plate is fixedly attached to the magnetic conductive plate by means of the magnets on the moving plate. The group head is located at a front side of the front plate and fixed on the moving plate, and in the absence of an external force, the moving plate remains stationary due to attraction of the magnets such that the group head remains stationary.

Further, the moving plate includes a flat plate portion and a guide protrusion portion connected to the flat plate portion. The guide protrusion portion has a front protrusion, and the front protrusion runs into the guide opening and is connected with the group head. The flat plate portion is attached to a rear side of the magnetic conductive plate, and the magnets are assembled on the flat plate portion.

Further, the guide protrusion portion of the moving plate has a through opening running through the guide protrusion portion from front to rear and fixing portions located on two sides of the through opening. The fixing portions are fixedly connected to the group head, and an electrical connecting wire or a water tube of the group head runs through the through opening of the moving plate.

Further, the fixing portions are fixing holes, and the moving plate and the group head are fixedly assembled by means of fixing members running through the fixing holes.

Further, there are four magnets which are respectively mounted at four end portions of the flat plate portion.

Further, the group head has a guide protrusion portion, and the guide protrusion portion of the group head is connected to the moving plate after running through the guide opening.

Further, the moving structure for a group head further includes a fixed plate. The fixed plate is fixed to the rear side portion of the front plate. The fixed plate is provided with an accommodating recess, and the accommodating recess covers the moving plate and the magnets to restrict the moving plate and the magnets from separation.

Further, the moving plate is provided with a rear protrusion protruding backward, and the accommodating recess of the fixed plate has a guide groove matched with the rear protrusion.

Further, the moving plate has a through opening running through the moving plate from front to rear, and a side wall of the guide groove parallel with a moving direction of the moving plate is hollowed. An electrical connecting wire or a water tube of the group head runs through the through opening of the moving plate and runs out of the side wall of the guide groove.

Further, the front plate forms an accommodating recess on a periphery of the guide opening, and the group head is accommodated in the accommodating recess.

A coffee machine includes at least the moving structure for a group head described above.

The technical solution provided by this application has the following beneficial effects:

According to this solution, the group head is fixed by means of the attraction of the magnets instead of frictional resistance. In this way, direct friction is reduced, and the service life can be effectively prolonged. Moreover, the assembly structure is simple and easy to implement.

### BRIEF DESCRIPTION OF DRAWINGS

FIG. 1 is a schematic view I showing appearance of a moving structure for a group head in Example I;

FIG. 2 is a schematic view II showing the appearance of the moving structure for a group head in Example I;

FIG. 3 is a schematic structural exploded view of the moving structure for a group head in Example I;

FIG. 4 is a schematic partial structural view of the moving structure for a group head in Example I after a fixed plate is hidden;

FIG. 5 is a schematic structural view I of a moving plate in Example I;

FIG. 6 is a schematic structural view II of the moving plate in Example I;

FIG. 7 is a schematic structural view I of the fixed plate in Example I;

FIG. 8 is a schematic structural view II of the fixed plate in Example I; and

FIG. 9 is a schematic structural view of a group head in Example III.

### DESCRIPTION OF EMBODIMENTS

To further illustrate the examples, the accompanying drawings are provided in this application. These accompanying drawings are a part of the contents disclosed in this application that are mainly used to illustrate the examples, and can be used in conjunction with the related descriptions in the specification to explain the operation principle of the examples. With reference to these contents, those of ordinary skill in the art should be able to understand other possible embodiments and advantages of this application. Components in the drawings are not drawn to scale, and like component symbols are usually used to represent like components.

This application will be further described in conjunction with the accompanying drawings and specific embodiments.

### Example I

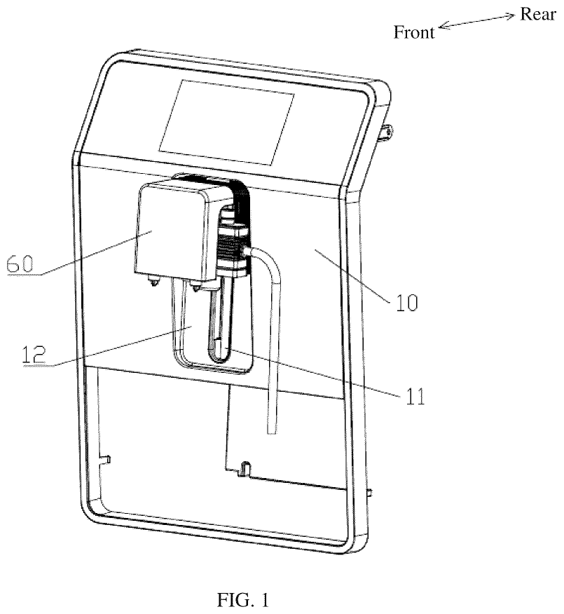

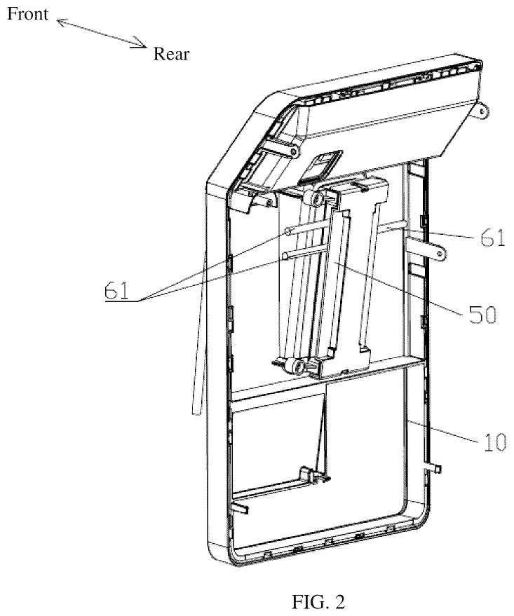

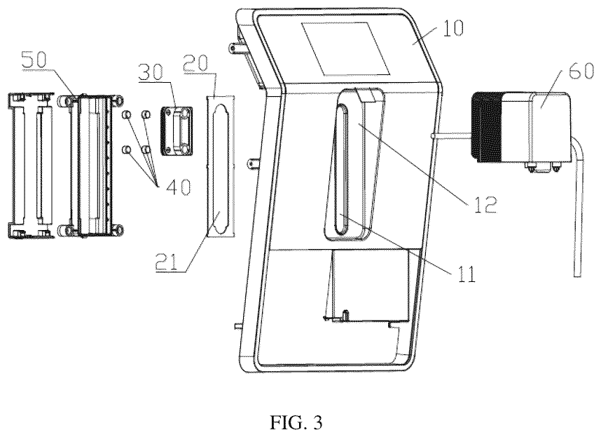

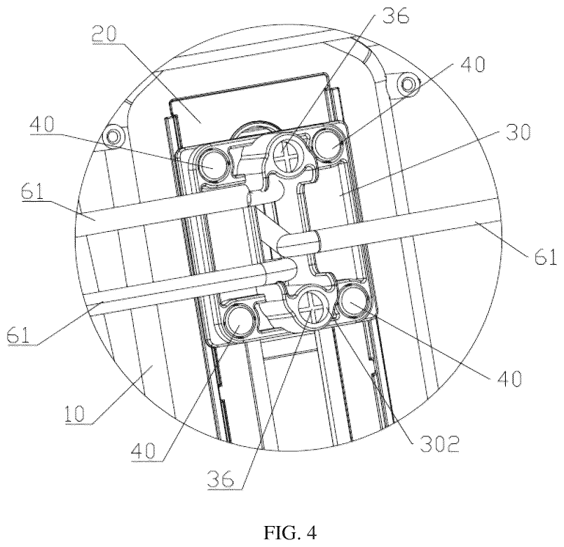

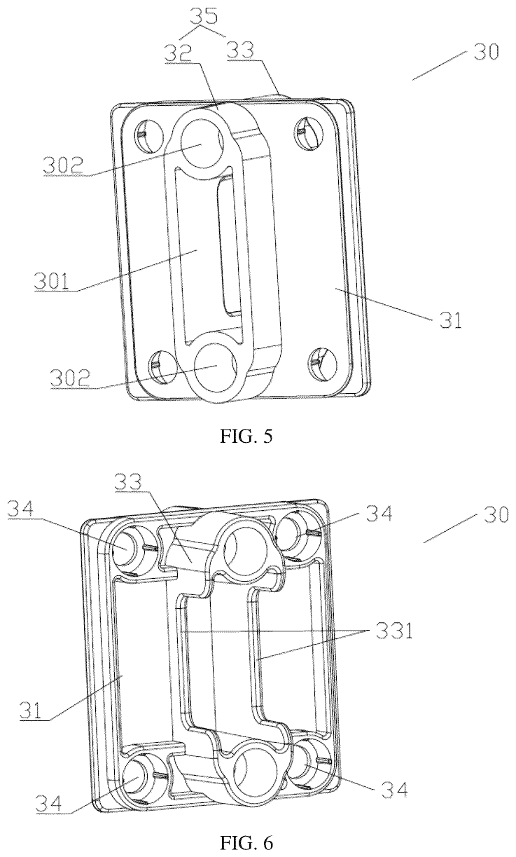

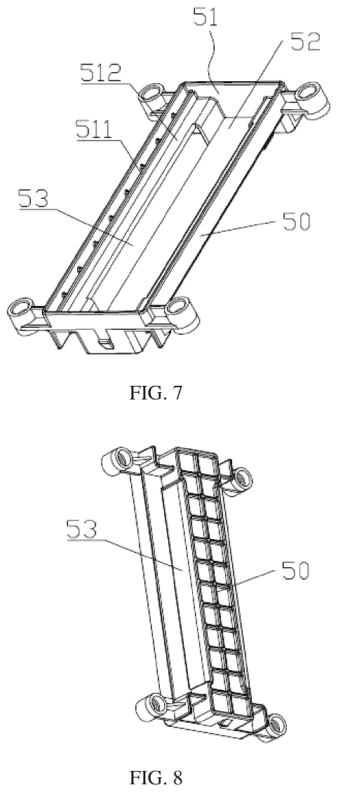

Referring to FIG. 1 to FIG. 8, a moving structure for a group head provided by this example includes a front plate 10, a magnetic conductive plate 20, magnets 40, a moving plate 30, and a fixed plate 50. The front plate 10 is provided with a guide opening 11 running through the front plate from front to rear. Specifically, the guide opening 11 is an elongated opening extending vertically. The magnetic conductive plate 20 is fixed to a rear side portion of the front plate 10. Specifically, the magnetic conductive plate 20 is an iron sheet, a middle of the magnetic conductive plate 20 has a give-way opening 21 having a slightly larger size than the guide opening 11, and the give-way opening 21 corresponds to the guide opening 11 and functions to give way.

The magnets 40 are assembled on the moving plate 30. The moving plate 30 is slidably assembled in the guide opening 11 and corresponds to the magnetic conductive plate 20, and the moving plate is fixedly attached to the magnetic conductive plate 20 by means of the magnets 40 on the moving plate. That is, the moving plate 30 forms a guide fit with the guide opening 11 so as to move up and down along an extending direction of the guide opening 11, and the magnets 40 are assembled on the moving plate 30 and magnetically attract the magnetic conductive plate 20. The group head 60 is located at a front side of the front plate 10 and fixed on the moving plate 30, and in the absence of an external force, the moving plate 30 remains stationary due to attraction of the magnets 40 such that the group head 60 remains stationary, i.e., at a certain height.

When the group head 60 needs to be moved, an external force is applied to the group head 60, for example, to press down or lift the group head 60, so that the group head 60 correspondingly moves up and down against the attraction of the magnets 40. After the external force is removed, the group head 60 is fixed again.

According to this solution, the group head 60 is fixed by means of the attraction of the magnets 40 instead of frictional resistance. In this way, direct friction is reduced, and the service life can be effectively prolonged. Moreover, the assembly structure is simple and easy to implement.

Specifically, in this example, the moving plate 30 includes a flat plate portion 31 and a guide protrusion portion 35 connected to the flat plate portion 31. The guide protrusion portion has a front protrusion 32, and the front protrusion 32 runs into the guide opening 11 and is connected with the group head 60. The flat plate portion 31 is attached to a rear side of the magnetic conductive plate 20, and the magnets 40 are assembled on the flat plate portion 31. In this way, the moving plate 30 cooperates with the guide opening 11 and the magnetic conductive plate 20, which is simple in structure.

The fixed plate 50 is fixed to the rear side portion of the front plate 10. The fixed plate 50 is provided with an accommodating recess 51, and the accommodating recess 51 covers the moving plate 30 and the magnets 40 to restrict the moving plate 30 and the magnets 40 thereon from separation. Specifically, the accommodating recess 51 has abutting ribs 511 and abutting flat plates 512. The abutting ribs 511 abut against the moving plate 30, and the abutting flat plates 512 abut against the magnets 40, thereby restricting the moving plate 30 and the magnets 40 from separation, and further ensuring the stability. Moreover, the fixed plate 50 also has a blocking function. That is, while the group head 60 moves up and down, the fixed plate prevents the user from seeing the inside of the coffee machine through the guide opening 11.

Moreover, the moving plate 30 is provided with a rear protrusion 33 protruding backward, i.e., the guide protrusion portion 35 further has the rear protrusion 33 protruding backward. The accommodating recess 51 of the fixed plate 50 has a guide groove 52 matched with the rear protrusion 33. The rear protrusion 33 is inserted into the guide groove 52 to realize a guide fit, i.e., the rear protrusion 33 is abutted and limited by the abutting flat plates 512 on the two sides so as to realize the guide fit. Thereby, both the front side and the rear side of the moving plate 30 form the guide fit, which is more stable.

The guide protrusion portion 35 of the moving plate 30 has a through opening 301 running through the guide protrusion portion from front to rear and fixing portions located on two sides (specifically, upper and lower sides) of the through opening 301, i.e., the through opening 301 runs through the front protrusion 32 and the rear protrusion 33. The fixing portions are fixedly connected to the group head 60. A side wall of the guide groove 52 parallel with a moving direction (up-down direction) of the moving plate 30 is hollowed, i.e., the side wall of the guide groove 52 extending up and down is hollowed to form an opening 53. A water tube 61 (which may also be an electrical connecting wire) of the group head 60 runs through the through opening 301 of the moving plate 30 and runs out of the side wall (i.e., the opening 53) of the guide groove 52. In this way, the water tube 61 of the group head 60 can move synchronously, the appearance is neat, and the water tube 61 is less prone to bend and breakage.

Notches 331 are formed in two side walls of the rear protrusion 33. The notches 331 function to give way. The water tube 61 of the group head 60 runs out from the notches 331, which saves the layout space.

Specifically, the fixing portions are fixing holes 302, and the moving plate 30 and the group head 60 are fixedly assembled by means of fixing members (such as bolts 36) running through the fixing holes 302, which makes the installation simpler.

There are four magnets 40 which are respectively mounted at four end portions of the flat plate portion 31, which provides more stable magnetic attraction. Specifically, the four end portions of the flat plate portion 31 are provided with four accommodating grooves 34, and the four magnets 40 are respectively assembled in the four accommodating grooves 34. Moreover, the rear side of the flat plate portion 31 and the magnets 40 is covered by the fixed plate 50.

Specifically, in this example, the front plate 10 forms an accommodating recess 12 on a periphery of the guide opening 11, and the group head 60 is accommodated in the accommodating recess 12, so that the connecting structure of the group head 60 can be hidden well, thereby providing a better appearance.

### Example II

A moving structure for a group head provided by this example is substantially the same as in Example I, except that: there is no fixed plate 50 in this example, and the guide protrusion portion 35 of the moving plate 30 does not have the rear protrusion 33. In order to prevent the magnets 40 from coming off, the magnets 40 may be fixed to the moving plate 30 by means of gluing, snap fit, etc.

The magnetic conductive plate 20 includes two strip-shaped iron sheets that are distributed on the left and right sides of the guide opening 11, which can also realize the cooperation with the magnets 40.

### Example III

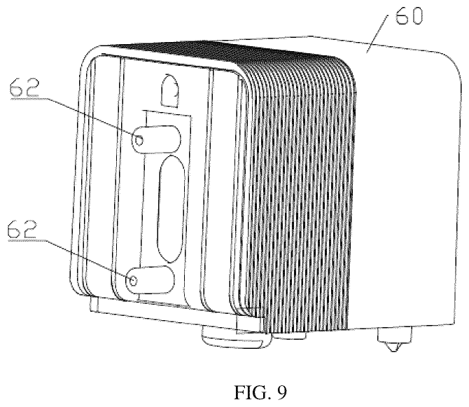

A moving structure for a group head provided by this example is substantially the same as in Example I, except that: as shown in FIG. 9, the group head 60 has a guide protrusion portion 62, and the guide protrusion portion 62 of the group head 60 is connected to the moving plate 30 after running through the guide opening 11, which can also realize guiding and connection.

### Example IV

This example provides a coffee machine, including at least the moving structure for a group head as described in Example I or Example II. That is, the group head 60 is installed by means of the above moving structure.

Although this application has been specifically shown and described in connection with the preferred embodiments, it should be understood by those skilled in the art that various changes in form and details can be made to this application without departing from the spirit and scope of this application as defined by the appended claims, and shall all fall within the protection scope of this application.

1. A moving structure for a group head, comprising a front plate, a magnetic conductive plate, magnets and a moving plate, wherein the front plate is provided with a guide opening running through the front plate from front to rear, the magnetic conductive plate is fixed to a rear side portion of the front plate, the magnets are assembled on the moving plate, the moving plate is slidably assembled in the guide opening and corresponds to the magnetic conductive plate, the moving plate is fixedly attached to the magnetic conductive plate by means of the magnets on the moving plate, the group head is located at a front side of the front plate and fixed on the moving plate, and in the absence of an external force, the moving plate remains stationary due to attraction of the magnets such that the group head remains stationary.

2. The moving structure for a group head according to claim 1, wherein the moving plate comprises a flat plate portion and a guide protrusion portion connected to the flat plate portion, the guide protrusion portion has a front protrusion, the front protrusion runs into the guide opening and is connected with the group head, the flat plate portion is attached to a rear side of the magnetic conductive plate, and the magnets are assembled on the flat plate portion.

3. The moving structure for a group head according to claim 2, wherein the guide protrusion portion of the moving plate has a through opening running through the guide protrusion portion from front to rear and fixing portions located on two sides of the through opening, the fixing portions are fixedly connected to the group head, and an electrical connecting wire or a water tube of the group head runs through the through opening of the moving plate.

4. The moving structure for a group head according to claim 3, wherein the fixing portions are fixing holes, and the moving plate and the group head are fixedly assembled by means of fixing members running through the fixing holes.

5. The moving structure for a group head according to claim 1, wherein the group head has a guide protrusion portion, and the guide protrusion portion of the group head is connected to the moving plate after running through the guide opening.

6. The moving structure for a group head according to claim 1, further comprising a fixed plate, wherein the fixed plate is fixed to the rear side portion of the front plate, the fixed plate is provided with an accommodating recess, and the accommodating recess covers the moving plate and the magnets to restrict the moving plate and the magnets from separation.

7. The moving structure for a group head according to claim 6, wherein the moving plate is provided with a rear protrusion protruding backward, and the accommodating recess of the fixed plate has a guide groove matched with the rear protrusion.

8. The moving structure for a group head according to claim 7, wherein the moving plate has a through opening running through the moving plate from front to rear, a side wall of the guide groove parallel with a moving direction of the moving plate is hollowed, an electrical connecting wire or a water tube of the group head runs through the through opening of the moving plate and runs out of the side wall of the guide groove.

9. The moving structure for a group head according to claim 1, wherein the front plate forms an accommodating recess on a periphery of the guide opening, and the group head is accommodated in the accommodating recess.

10. A coffee machine, comprising at least the moving structure for a group head according to claim 1.

11. The coffee machine according to claim 10, wherein the moving plate comprises a flat plate portion and a guide protrusion portion connected to the flat plate portion, the guide protrusion portion has a front protrusion, the front protrusion runs into the guide opening and is connected with the group head, the flat plate portion is attached to a rear side of the magnetic conductive plate, and the magnets are assembled on the flat plate portion.

12. The coffee machine according to claim 11, wherein the guide protrusion portion of the moving plate has a through opening running through the guide protrusion portion from front to rear and fixing portions located on two sides of the through opening, the fixing portions are fixedly connected to the group head, and an electrical connecting wire or a water tube of the group head runs through the through opening of the moving plate.

13. The coffee machine according to claim 12, wherein the fixing portions are fixing holes, and the moving plate and the group head are fixedly assembled by means of fixing members running through the fixing holes.

14. The coffee machine according to claim 10, wherein the group head has a guide protrusion portion, and the guide protrusion portion of the group head is connected to the moving plate after running through the guide opening.

15. The coffee machine according to claim 10, further comprising a fixed plate, wherein the fixed plate is fixed to the rear side portion of the front plate, the fixed plate is provided with an accommodating recess, and the accommodating recess covers the moving plate and the magnets to restrict the moving plate and the magnets from separation.

16. The coffee machine according to claim 15, wherein the moving plate is provided with a rear protrusion protruding backward, and the accommodating recess of the fixed plate has a guide groove matched with the rear protrusion.

17. The coffee machine according to claim 16, wherein the moving plate has a through opening running through the moving plate from front to rear, a side wall of the guide groove parallel with a moving direction of the moving plate is hollowed, an electrical connecting wire or a water tube of the group head runs through the through opening of the moving plate and runs out of the side wall of the guide groove.

18. The coffee machine according to claim 10, wherein the front plate forms an accommodating recess on a periphery of the guide opening, and the group head is accommodated in the accommodating recess.
